(19) United States
(12) Patent Application Publication
(10) Pub. No.: US 2006/0047797 A1
(43) Pub. Date: Mar. 2, 2006

(54) System and method for determining one of a plurality of shells based on user identification information

(76) Inventors: Norman P. Brown, Tomball, TX (US); Sam Jung-Won Lee, Spring, TX (US); Raymond E. Shapiro, Marlborough, MA (US); William R. Whipple, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/872,734

(22) Filed: Jun. 21, 2004

(51) Int. Cl. G06F 15/173

(52) U.S. Cl. 709/223

(57) ABSTRACT

According to one embodiment, a system comprises a processor-based device and a startup application that is operable to determine one of a plurality of different shells presented by the processor-based device based on a user's identity information.

### BACKGROUND

Many enterprises currently employ computer systems based on the client/server architecture. In a client/server architecture, a client computer (usually a user computer, such as a PC) requests a number of resources from server applications (usually on a larger, specialized computer), such as data, applications, and some processing. Clients and servers are connected over a network, such as a Local Area Network (LAN) or a Wide Area Network (WAN), and many computer systems employ one or more applications servers and one or more database servers to communicate with many clients and to provide them with a full range of applications and data.

Some systems may utilize general-purpose PCs as “fat clients.” In other words, while the client computer will receive some applications and processing from the server, most of the storage and processing will occur at the client, which may include multiple storage devices (hard drive, floppy drive, CR ROM drive, etc.) on which many programs are stored and ready to run with little or no input from the server. In such systems, the server's main function may be that of a remote hard drive, simply storing and retrieving programs and data while doing little processing for client application uses.

Some systems may utilize what are referred to as “thin clients.” Thin clients can be any type of computer, but are usually stripped-down versions of a user computer with very minimal storage capacity. In a thin client arrangement, much of the processing may be accomplished by the server, as well as much of the application storage. Thus, some thin client arrangements may be considered highly centralized because most of the functionality and storage resides on the server side while the clients operate almost as dumb terminals.

Many computers, including servers, clients, stand-alone computers, and the like present an interface to a user that may be referred to as a “shell.” A shell is an interactive interface that defines a maximum amount of system features that are accessible by the user. Some systems may be operable to associate a given shell with a computer (e.g., based on a computer's operating system) and may also allow a user to configure the shell in some way. However, traditional systems do not allow shells to be selected on a per-user basis.

### SUMMARY

According to at least one embodiment, a system comprises a processor-based device and a startup application that is operable to determine one of a plurality of shells presented by the processor-based device based on a user's identity information. According to at least one other embodiment, a method comprises receiving an identification of a user and determining a shell specified for the user based on the identification. According to at least one other embodiment, a system comprises means for matching user identification information to a corresponding user profile and means for executing a shell specified by the profile

### BRIEF DESCRIPTION OF THE DRAWINGS

FIG. 1A is an illustration of an example system adapted according to various embodiments;

FIGS. 1B and 1C are illustrations of exemplary shells adapted according to various embodiments;

FIG. 2 is a functional diagram of an example WINDOWS® CE-based thin client system, adapted according to various embodiments, for presenting a shell to a user;

FIG. 3A is an illustration of an example system, adapted according to the embodiment depicted in FIG. 2, for presenting a shell to a user;

FIG. 3B is an illustration of an example system, adapted according to the embodiment depicted in FIG. 2, for presenting a shell to a user;

FIG. 4 is an illustration of example system 400, adapted according to various embodiments;

FIG. 5 is a block diagram illustrating exemplary method 500 for presenting a shell to a user; and

FIG. 6 illustrates an example computer system 600 adapted according to various embodiments provided herein.

### DETAILED DESCRIPTION

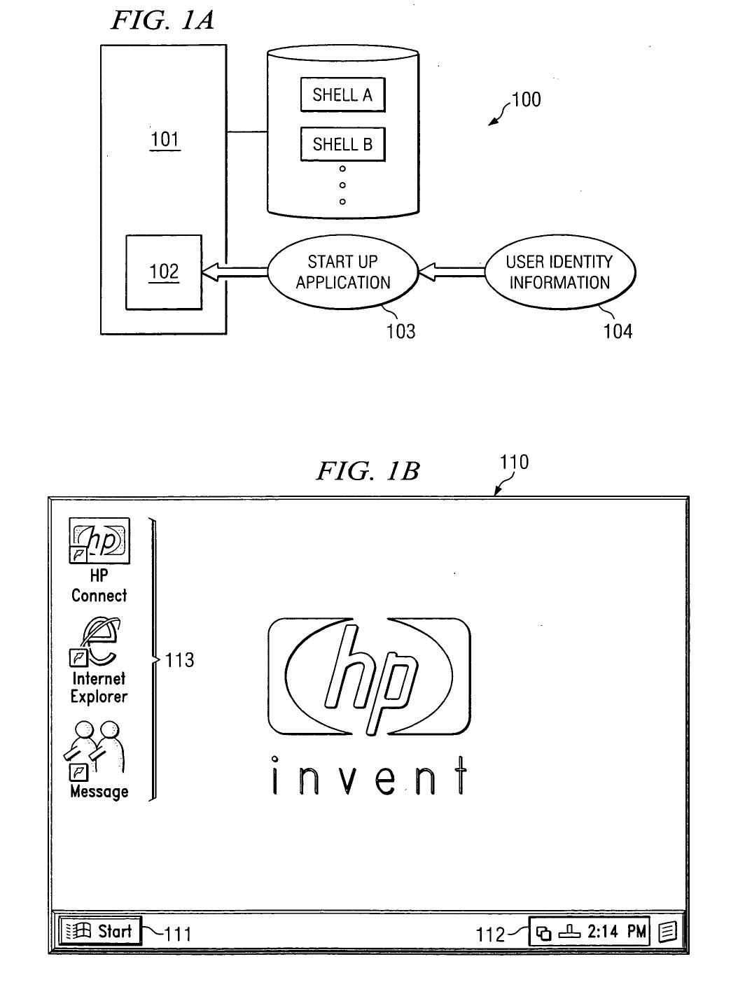

FIG. 1A is an illustration of example system 100, adapted according to various embodiments for determining one of a plurality of different shells to present to a user. System 100 includes computer 101, shell 102 (presented by computer 101), startup application 103, and user identity information 104. In this example, user identity information 104 is received by startup application 103, which uses information 104 to determine a shell (in this case, shell 102) to be presented by computer 101. According to this example, any of a plurality of different shells, such as shells A and B (stored to data storage), may be presented on computer 101.

As mentioned above, startup application 103 is operable to determine a shell based on user identity information 104. In many embodiments, such functionality may include matching information 104 to entries in a database or configuration file that may be internal or external to startup application 103 or computer 101. While FIG. 1A depicts startup application 103 as being outside of computer 101, many embodiments may locate startup application 103 on computer 101. Further, while many of the examples herein describe embodiments that employ a thin client computer, various embodiments may employ one or more other types of computers, such as servers, fat clients, stand-alones, or a combination thereof. Particular embodiments disclosed herein may be especially suited for use on thin client systems.

Because system 100 determines shell 102 based on user identity information 104, system 100 may be operable to provide a number of different shells to a number of different users. A shell may be appropriate for a particular user based on, for example, security issues and user permissions, as explained more fully below. FIGS. 1B and 1C are illustrations of exemplary shells adapted according to various embodiments. Specifically, FIG. 1B is an illustration of Explorer shell 110, which may be presented by computer 101. Many thin client systems use WINDOWS® CE operating system, which is capable of running an application to provide a shell similar to shell 110 as an interface for a user.

Explorer shell 110 provides much functionality (for a thin client system), including start menu 111, which may give a user access to one or more applications, one or more connections, a control panel, and other resources, such as the ability to add, delete, or modify available applications and connections. Explorer shell 110 also may include icons 113, which may be shortcuts to one or more applications or connections. An application may be considered to be a program for use on computer 101, such as INTERNET EXPLORER, which is a web browser application, or WINDOWS® MEDIA® PLAYER, which is a multi-media application. A connection may be considered to be a communication connection to a server, such that by choosing a connection, a user may become connected to a server and be able to access the features offered by that server. An example of a connection is a CITRIX® ICA® server connection, that may allow a user at a client computer to access many licensed applications available through the server, such as word processing or database applications. Some features may be both an application and a connection, such as INTERNET EXPLORER, which may be a program that resides, at least partly, on a thin client, but also connects the client to a specific server for Internet access.

System tray 112 may also be provided by Explorer shell 110, thereby providing a clock and notifications to a user. In addition to allowing a user some degree of latitude in access to connections and other features, Explorer shell 110 may offer the advantage of providing some users with an interface that feels familiar because it resembles a WINDOWS® XP or CE interface, which is a popular business and consumer operating system. Some network administrators may consider the broad access to features offered by Explorer shell 110 to be a disadvantage in that some users may abuse their access to some of the features, such as by frivolously surfing the Web with an INTERNET EXPLORER application or causing security breaches. This illustrates a common theme in Information Technology (IT), which is finding a balance between user access and security, wherein one is usually increased at the expense of the other. Accordingly, an Explorer shell may offer less security to a computer system than a more restrictive shell.

FIG. 1C is an illustration of another example shell 120, that may be selectively presented to a user according to certain embodiments. Because of the broad access offered to users by shell 110 of FIG. 1B, some network administrators may prefer a Connection Manager shell, such as shell 120 of FIG. 1C. Shell 120, in this example, provides access to connections and applications 125. A user wishing to access a particular application or connection moves a cursor to highlight a choice (such as RDP) and clicks on the “connect” button 126. System tray 122 may also be provided by Connection Manager 120, thereby providing a clock and notifications to a user. A user may also access minimize, maximize, and close buttons 123 or start menu 121. A user who interacts with a system through shell 120 will have a more limited range of access than a user who interacts through shell 110, mostly because shell 120 does not provide access to a full start menu. For example, in this shell a user who clicks on start menu 121 may be presented a “shut down” item only. While buttons 126 provide “delete,” “add,” “edit,” and “control panel” options, the range of actions available through such buttons may be severely limited when compared to the range of actions offered through shell 110. Thus, in most cases, a user who interacts through shell 120 will be able to access only the connections and applications 125 and a few limited functions offered by buttons 126. Further, in most cases, clicking on the close button, the “exit” button, or “OK” button 124 logs a user off rather than sending the user to a more broad access interface.

While FIGS. 1B and 1C depict two examples of shells, the various embodiments presented herein are not limited to those shells. Accordingly, other shells now known or later developed may be supported in addition to or instead of the shells of FIGS. 1B and 1C in one or more embodiments. One example of a shell that may offer a high level of security by severely limiting access to features is a shell that includes only a connection or an application interface, such as an INTERNET EXPLORER shell. In such an embodiment, a user of computer 101 may see only an INTERNET EXPLORER screen and will only be able to access those features that are provided by INTERNET EXPLORER. Because it is a shell, rather than just an application interface, it defines the maximum amount of system features that the user may access. Therefore, closing INTERNET EXPLORER may log the user off or turn the computer off rather than sending the user to a more broad-access interface. This effectively provides a “kiosk” mode, wherein the client computer provides only the INTERNET EXPLORER interface.

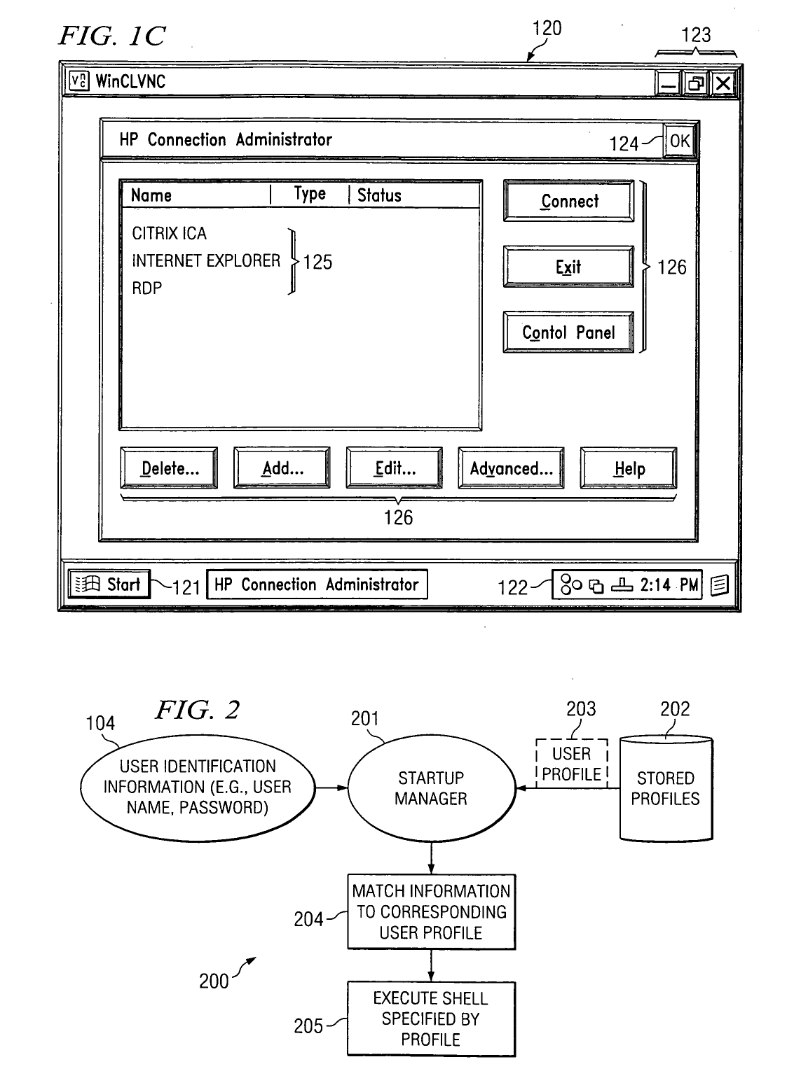

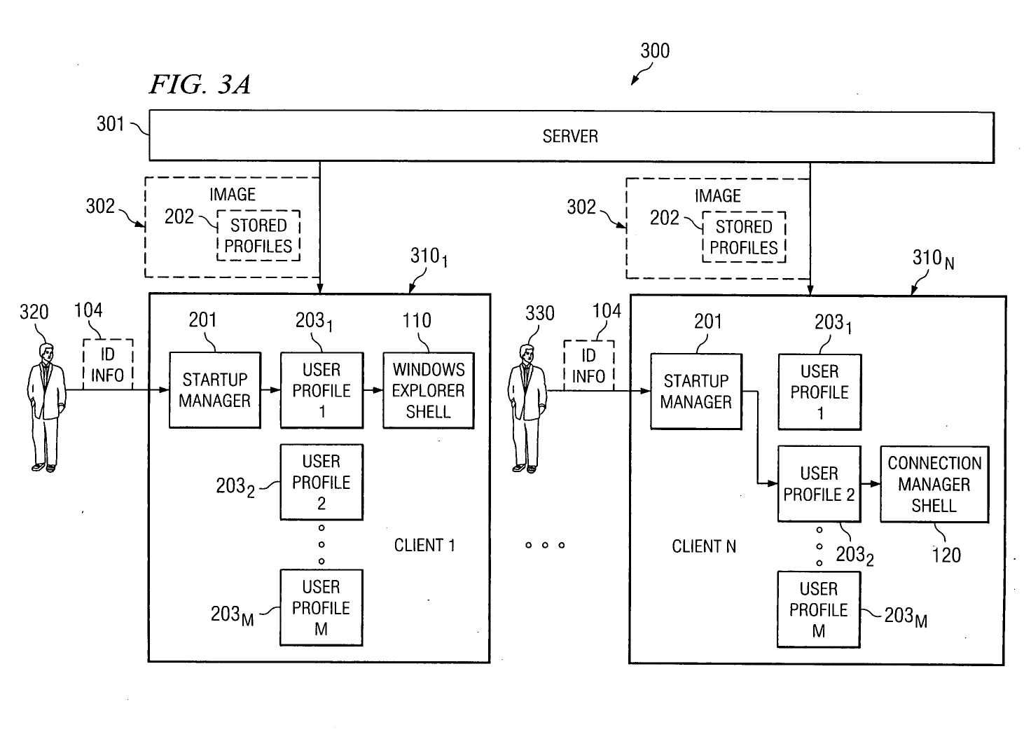

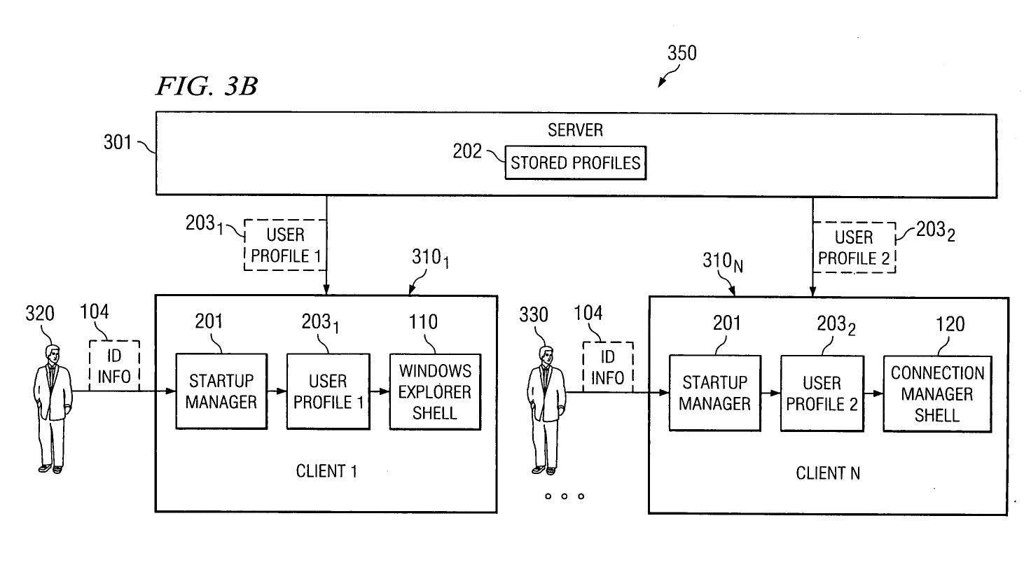

Referring to FIG. 1A, in an example embodiment, User A may log onto computer 101, and computer 101 may prompt User A to enter a login ID and password, which constitutes, in this example, user identity information 104. Of course, any other technique now known or later developed for identifying User A may be employed, such as fingerprint recognition, voice recognition, and the like. Thus, user identity information 104 may inform computer 101 that User A is the current user. Startup application 103 then determines shell 102 to be presented by computer 101 to User A based on information 104. In some embodiments, startup application 103 may include functionality such that it queries a database or configuration file to determine which shell 102 is appropriate, as explained more fully below with regard to FIGS. 2-3B. Other systems may provide other functionality to determine shell 102, and are within the scope of various embodiments.

In one example, startup application 103 determines that shell 110, instead of shell 120, is appropriate for presenting to User A by computer 101. Shell 110 may be more appropriate for User A based on such criteria as User A's preferences or privileges afforded User A by an administrator. In another example, startup application 103 may determine that shell 120 is appropriate for User A because of the limited access that it offers for some features. Thus, system 100 provides a way to execute shells on a per-user basis. Note that users may be grouped according to many criteria (e.g., sales department versus accounting department), and shells may be assigned based on user group.

FIG. 2 is a functional diagram of example WINDOWS® CE-based thin client system 200, adapted according to various embodiments, for presenting a shell to a user. In system 200, user identity information 104 is presented to startup manager 201. In this embodiment, startup manager 201 is a routine stored locally on a thin client that executes during the initialization chain of the thin client or at login of a user. Stored profiles 202 contain a number of user profiles, including user profile 203, and startup manager 201 can access user profile 203 in order to determine a specified shell for a user.

Blocks 204 and 205 represent functionality of startup manager 201. In block 204, user identity information 104 is matched to corresponding user profile 203. As explained with regard to FIGS. 3A and 3B in more detail below, in some embodiments, stored profiles 202 may be stored locally on the client so that startup manager 201 searches, for example, in the WINDOWS® registry to match corresponding user profile 203 to identity information 104. In other embodiments, stored profiles 202 may be stored remotely from the client, such that startup manager 201 must query, for example, a default server to match user profile 203 to information 104. Whether locally or remotely, any manner of storing and accessing stored profiles 202 are within the scope of various embodiments.

In block 204, the shell specified by profile 203 is executed. As explained earlier, user profile 203 specifies a shell for use with the particular user. Startup manager 201 uses that information to determine the appropriate shell. In WINDOWS® CE embodiments, one of the last steps in the initialization chain is to execute the shell. In this case, the shell is executed based on user identity information 104. The result is a WINDOWS® CE-based system that presents a shell to a user based on the user's identity (i.e., shells are executed on a per-user basis). That is, a selected one of a plurality of different shells that are available for execution on the client is executed for a given user based on that user's profile.

It is an advantageous feature of some embodiments to select a particular shell at initialization, rather than at run time, because navigation in each shell may be quite different from navigation in other shells, and such a feature may allow a user to interact with the shell that he or she is most comfortable with up front. Having a runtime selection may be useful in some embodiments; however, a user may have to interact with an interface that is less familiar to him or her before reaching a desired interface.

FIG. 3A is an illustration of example system 300, adapted according to the embodiment depicted in FIG. 2, for presenting one of plurality of different shells to a user. System 300 includes server 301 and up to N thin clients, represented by clients 310₁ through 310_{N} (where intervening clients 310₂-310_{N-1} are represented by ellipses). Thin clients 310 operate through use of image 302, which is a package of applications, including an operating system for thin clients 310. Image 302, in addition to an operating system, may also include other routines and data, and in this case, includes stored profiles 202. In this example, image 302 and stored profiles 202 are saved locally on each of the N clients 310.

System 300, in this example, uses WINDOWS® CE as its operating system. WINDOWS® CE has an initialization chain in its registry that begins with various boot routines and ends with executing a shell. In this embodiment, a routine (startup manager 201) is added to the initialization chain that prompts a user (such as user 320 or 330) for a login ID and password. Some embodiments may provide for execution of startup manager 201 at any login, not just at startup. After the user has entered the identity information, startup manager 201 searches stored profiles 202, which is a database in the User Settings part of the registry that includes user profiles 203₁-203_{M} to specify a shell for use with a particular user. Startup manager 201 then executes the specified shell. Thus, the embodiment depicted in FIG. 3A provides for shells on a per-user basis.

For example, in the case of client 310₁, image 302, which includes stored profiles 202, is stored on flash memory inside client 310₁. When user 320 restarts or logs onto client 310₁, user 320 is prompted for a login ID and password by the startup manager. User 320 then identifies himself with ID information 104. Startup manager 201 then compares information 104 to profiles 203, and finds a match with profile 203₁. Profile 203₁, in this case, specifies that Explorer shell 110 is appropriate for use with user 320. Accordingly, shell 110 is executed. Client 310_{N} operates in a similar manner to compare information 104 for user 330 with profiles 203 to execute shell 120.

Clients 310 and server 301 may belong to an enterprise that employs many people, and therefore, must accommodate many users in system 300. Because image 302 is stored on clients 310 themselves, it is possible to use a different image with different stored profiles on one or more of the N clients in system 300. In order to keep image 302 and stored profiles 202 consistent from client to client, an administrator may reimage all N clients every time a user profile 203 in stored profiles 202 changes. Thus, a user (such as user 320 or 330) may log on to any of the N clients 310, and the same shell will be presented each time.

FIG. 3B is an illustration of example system 350, adapted according to the embodiment depicted in FIG. 2, for presenting a shell to a user. System 350, like system 300, is operable to determine a shell based on a user's identity information, but is different from system 300 in that stored profiles 202 are stored on server 301 rather than on clients 310 locally. A scenario involving system 350 may begin with user 320 being prompted for identity information 104 by startup manager 201 at client 310₁. When user 320 submits requested information 104, startup manager 201 queries server 301, which supplies profile 203₁ (the profile corresponding to user 320). Profile 203₁ specifies shell 110 for use with user 320. Startup manager then executes shell 110, which is presented to user 320 to interface with client 310₁. In a similar manner, startup manager 201, on client 310_{N}, uses user identity information 104 from user 330 to receive profile 203₂ and execute shell 120.

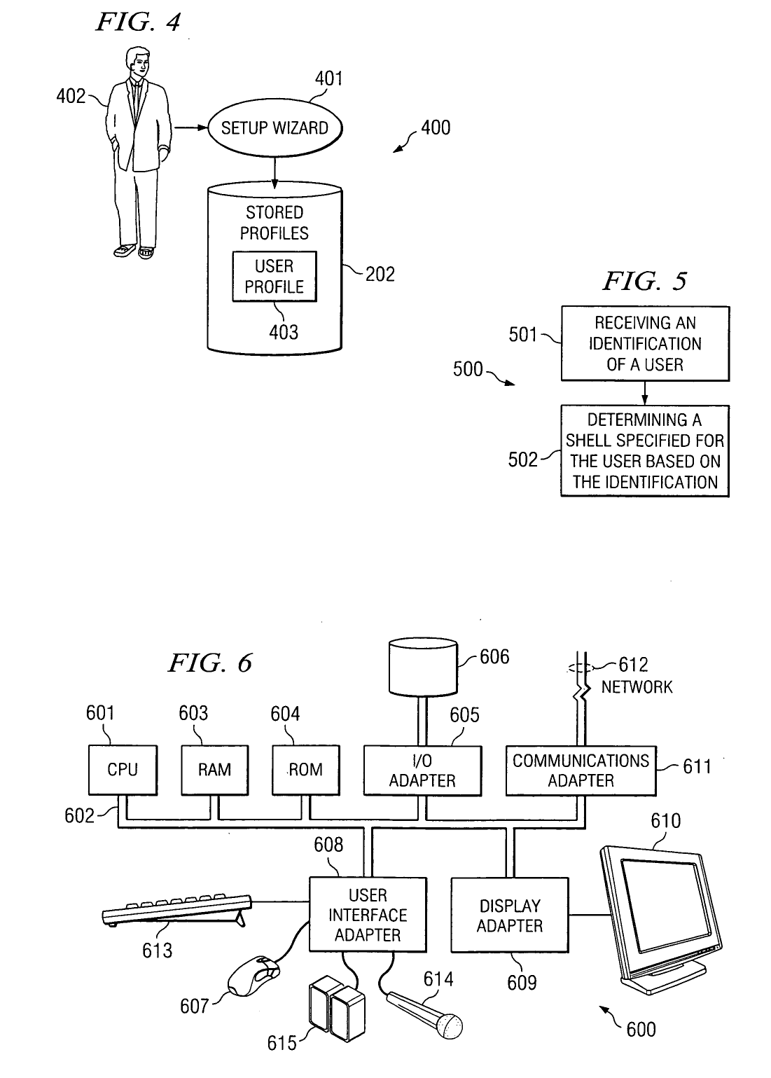

FIG. 4 is an illustration of example system 400, adapted according to various embodiments. In some WINDOWS® CE-based systems (and other systems employing different operating systems), it may be possible to implement a utility that is operable to walk a user or administrator through specifying settings, including which shell to execute for a particular user. System 400 includes setup wizard 401 to accomplish such function.

In this example embodiment, a wizard is an executable (.EXE) file with one or more dialog boxes that link to each other. Each dialog box may be designed to give a user a choice about one or more personal settings preferences. A wizard may be created from scratch, or may be created through modifying the source code of another existing wizard.

In some example embodiments, user 402 is not an administrator, but has authority to set up some of his own settings. User 402 accesses setup wizard 401, which walks him through a routine wherein he is prompted to enter some of his setting preferences. One of the preferences may be which shell he prefers to execute when he logs on. Setup wizard 401 then implements that preference in corresponding user profile 403, which may be one of several stored profiles 202.

In another example, user 402 is an administrator who desires to set preferences for a user other than himself. In that case, user 402 executes setup wizard 401, which prompts him to specify some settings, including which shell to execute for the user in question. Setup wizard 401 then implements the setting in corresponding user profile 403.

System 400 may be implemented in a computer system such as system 300 (FIG. 3A), wherein stored profiles 202 are stored on each client in the image. In such a scenario, the image may be copied to each client in the system so that user information is consistent among all clients. System 400 may also be implemented in a system such as system 350 (FIG. 3B), wherein stored profiles 202 are stored on a server and queried by clients when a user logs on. In such a case, setup wizard 401 may communicate with the server to modify user profile 403.

While the example embodiment described in FIG. 4 employs a setup wizard to create or change user profiles, other techniques may be used also. For instance, some embodiments may use one or more control panel applet dialog boxes to select user settings on a per-user basis. Whether an embodiment uses a setup wizard or control panel applet dialog boxes to select user preferences, it is within the scope of various embodiments to allow an administrator to restrict the use thereof, and in some cases, to restrict such use to administrator access only.

Further, while the embodiments described with regard to FIGS. 1B-4 employ WINDOWS® CE-based systems, other types of systems may also be used in various embodiments, such that the scope of embodiments is not limited by operating system. For example, an alternate embodiment uses a Linux-based system and stores user profiles in a configuration file (instead of in a WINDOWS® registry), wherein a startup application determines a shell presented by the computer based on user identity information.

FIG. 5 is a block diagram illustrating exemplary method 500 for providing a shell for a user. In block 501, an identification of a user is received. The identification may include text-based information (login ID, password, name, etc.), biometric information (such as retinal patterns or hand geometry), or the like. The identification can be received by a server, a client, a stand-alone computer, or any kind of computer system conforming to an architecture now know or later developed; however, method 500 may be particularly suited for use on a thin client.

In block 502, a shell specified for the user is determined based on the identification. The determining may be accomplished, for example, through use of querying a database or configuration file to access a profile corresponding to the user. The database or configuration file may be stored locally on the machine by which the identification was received, or it may be stored remotely from that machine. Further, the shell may be any shell now known or later developed. In many embodiments, method 500 may be performed at startup or login of a computer or computer system. In those embodiments, the determining a shell 502 may be followed by completion of a startup process through execution of the shell. Thus, such a method may be used in some embodiments to execute shells on a per-user basis.

FIG. 6 illustrates an example computer system 600 adapted according to various embodiments provided herein. That is, computer system 600 comprises an example system on which aspects of various embodiments may be implemented (such as computer 101 of the example implementation of FIGS. 1, 3A, and 3B and server computer 301 of the example implementation of FIGS. 3A and 3B). Central processing unit (CPU) 601 is coupled to system bus 602. CPU 601 may be any general purpose or specialized CPU, and the present invention is not restricted by the architecture of CPU 601 as long as CPU 601 supports the inventive operations as described herein. CPU 601 may execute the various logical instructions according to embodiments of the present invention. For example, CPU 601 may execute machine-level instructions according to the exemplary operational flows described above in conjunction with FIGS. 2 and 5.

Computer system 600 may also include random access memory (RAM) 603, which may be SRAM, DRAM, SDRAM, or the like. Computer system 600 may include read-only memory (ROM) 604 which may be PROM, EPROM, EEPROM, or the like. In some embodiments, RAM 603 may provide reading and writing of data during an operation, and ROM 604 may accommodate a Basic Input Output System (BIOS).

Computer system 600 may also include input/output (I/O) adapter 605, communications adapter 611, user interface adapter 608, and display adapter 609. I/O adapter 605, user interface adapter 608, and/or communications adapter 611 may, in certain embodiments, enable a user to interact with computer system 600 in order to input information, such as to operate setup wizard 401 of FIG. 4.

I/O adapter 605 may connect to storage device(s) 606, such as one or more of a flash memory, hard drive, compact disc (CD) drive, floppy disk drive, tape drive, etc. to computer system 600. In the case of thin clients, local storage may be restricted to RAM 603, ROM 604, and flash memory. In example clients 310 (of FIGS. 3A and 3B), a flash memory may be used to store image 302 after installation. Communications adapter 611 is adapted to couple computer system 600 to network 612 (and may connect clients 310 to server 301 of FIGS. 3A and 3B). User interface adapter 608 couples user input devices, such as keyboard 613, pointing device 607, and microphone 614 and/or output devices, such as speaker(s) 615 to computer system 600. Display adapter 609 is driven by CPU 601 to control the display on display device 610 to, for example, display a user interface at client 310 (FIGS. 3A and 3B) for a user to input instructions to startup manager 201 (FIGS. 2-3B) in some embodiments.

It shall be appreciated that the various embodiments are not limited to the architecture of system 600. For example, many suitable processor-based devices may be utilized for either client 310 or server 301 (FIGS. 3A and 3B). Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

What is claimed is:

1. A system comprising:
a processor-based device; and
a startup application that is operable to determine one of a plurality of different shells presented by the processor-based device based on a user's identity information.

2. The system of claim 1 wherein the processor-based device runs Linux, and one or more user profiles are stored in a configuration file.

3. The system of claim 1 wherein the processor-based device is a thin client.

4. The system of claim 3 wherein the thin client runs WINDOWS® CE.

5. The system of claim 1 wherein the startup application is a startup manager operable to access one or more user profiles during an initialization chain.

6. The system of claim 5 wherein the one or more user profiles are stored on a server.

7. The system of claim 5 wherein the one or more user profiles are stored locally on the processor-based device in a registry.

8. The system of claim 1 wherein the shell is an interactive user interface that defines the maximum amount of system features accessible by the user.

9. The system of claim 1 wherein the shell is an Explorer shell.

10. The system of claim 1 wherein the shell is a connection interface.

11. The system of claim 1 wherein the processor-based device is selected from the group consisting of:
a fat client;
a PC;
a stand-alone computer; and
a Personal Digital Assistant (PDA).

12. A method comprising:
receiving an identification of a user; and
determining a shell specified for the user based on the identification.

13. The method of claim 12 wherein determining comprises:
accessing a user profile corresponding to the user; and
retrieving information that specifies the shell.

14. The method of claim 13 wherein the user profile is stored locally on a client in a WINDOWS® registry.

15. The method of claim 14 wherein the client is a thin client running WINDOWS® CE operating system.

16. The method of claim 12 wherein the receiving and determining are performed during an initialization chain.

17. The method of claim 12 further comprising executing the shell.

18. The method of claim 12 further comprising receiving an image from a server, wherein the image includes a user profile corresponding to the user.

19. The method of claim 12 wherein the shell is one a plurality of different shells available for use on a computer.

20. The method of claim 12 further comprising executing an INTERNET EXPLORER shell, thereby providing a kiosk mode for a computer.

21. A system comprising:
means for matching user identification information to a corresponding user profile; and
means for executing one of a plurality of shells specified by the profile.

22. The system of claim 21 wherein the means for matching and the means for executing comprise routines running on a thin client.

23. The method of claim 21 wherein the means for matching and means for executing comprise routines in an initialization chain in WINDOWS® CE.

24. The method of claim 23 wherein the means for matching and means for executing comprise a startup manager.

25. The method of claim 21 further comprising:
means for receiving the user identification information; and
means for retrieving information in the user profile which specifies the one of the plurality of shells.

26. The system of claim 21 wherein the user identification information is a login ID and password.

27. The system of claim 21 wherein the user profile is stored locally on a computer selected from the group consisting of:
a PC;
a stand-alone computer;
a server; and
a thin client.
